(19) United States
(12) Patent Application Publication
(10) Pub. No.: US 2026/0292170 A1
(43) Pub. Date: Sep. 24, 2026

(54) VIDEO ENCODING/DECODING METHOD AND APPARATUS FOR PREDICTING AND MODIFYING SPLIT STRUCTURE OF CODING TREE UNIT

(71) Applicants: Hyundai Motor Company, Seoul (KR); Kia Corporation, Seoul (KR); KWANGWOON UNIVERSITY-ACADEMIC COLLABORATION FOUNDATION, Seoul (KR)

(72) Inventors: Dong Gyu SIM, Seoul (KR); Han Sol CHOI, Dongducheon-si, Gyeonggi-do (KR); Min Hun LEE, Uijeongbu-si, Gyeonggi-do (KR); Jin HEO, Yongin-si, Gyeonggi-do (KR); Seung Wook PARK, Yongin-si, Gyeonggi-do (KR)

(73) Assignees: Kia Corporation, Seoul (KR); Hyundai Motor Company, Seoul (KR); KWANGWOON UNIVERSITY-ACADEMIC COLLABORATION FOUNDATION, Seoul (KR)

(21) Appl. No.: 19/132,477

(22) PCT Filed: Nov. 23, 2023
(86) PCT No.: PCT/KR2023/019023

§ 371 Date: May 28, 2026

(30) Foreign Application Priority Data
Nov. 25, 2022 (KR) 10-2022-0160938
Nov. 17, 2023 (KR) 10-2023-0159810

(51) Int. Cl. H04N 19/119; H04N 19/169; H04N 19/96

(52) U.S. Cl. CPC H04N 19/119; H04N 19/1883; H04N 19/96

(57) ABSTRACT

The present disclosure presents video encoding/decoding method and apparatus and provides a video decoding method including predicting a split structure of a current coding tree unit, determining a merging or non-merging of a current coding unit within the current coding tree unit with the split structure of the current coding tree unit, and merging the current coding unit or omitting the merging of the current coding unit based on the merging or non-merging of the current coding unit, determining a splitting or non-splitting of the current coding unit based on the merging or non-merging of the current coding unit, and determining the split structure of the current coding tree unit by splitting the current coding unit or omitting the splitting based on the splitting or non-splitting, and generating a prediction block of the current coding unit by using the split structure of the current coding tree unit.

### CROSS-REFERENCE TO RELATED APPLICATION

This application claims priority from Korean Patent Application No. 10-2022-0160938 filed on Nov. 25, 2022, and Korean Patent Application No. 10-2023-0159810 filed on Nov. 17, 2023, the disclosures of which are incorporated by reference herein in their entirety.

### TECHNICAL FIELD

The present disclosure in some embodiments relates to video encoding/decoding method and apparatus for predicting and modifying a split structure of a coding tree unit. More particularly, the present disclosure relates to video encoding/decoding methods and apparatus for predicting a split structure of a coding tree unit by using a convolutional neural network and modifying the predicted split structure of the coding tree unit.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

A video encoding apparatus recursively splits a coding tree unit (CTU) to determine the split structure of the coding tree unit. The split structure of the coding tree unit is a structure of the coding units (CUs) that constitute the coding tree unit. Upon determining the split structure of the coding tree unit, the video encoding apparatus transmits information about the split structure of the coding tree unit to a video decoding apparatus. The video decoding apparatus uses the information about the split structure of the coding tree unit to split the coding tree unit into coding units and reconstruct the samples of each coding unit. There is a need for the video encoding apparatus to transmit only part of the information about the split structure of the coding tree unit to increase the coding efficiency.

### DISCLOSURE

### Technical Problem

The present disclosure in some embodiments seeks to provide method and apparatus for predicting a split structure of a coding tree unit by using reference information and a convolutional neural network.

The present disclosure also seeks to provide method and apparatus for determining the split structure of a final coding tree unit by modifying the predicted split structure of the coding tree unit.

The present disclosure further seeks to provide method and apparatus for increasing video encoding/decoding efficiency.

The present disclosure further seeks to provide a recording medium storing a bitstream generated by video encoding/decoding method or apparatus of the present disclosure.

The present disclosure further seeks to provide a method and apparatus for transmitting a bitstream generated by the video encoding/decoding method or apparatus of the present disclosure.

### SUMMARY

The present disclosure in at least one embodiment provides a video decoding method including predicting a split structure of a current coding tree unit, determining a merging or non-merging of a current coding unit within the current coding tree unit by using the split structure of the current coding tree unit, and merging the current coding unit or omitting the merging of the current coding unit based on a determined merging or non-merging of the current coding unit, determining a splitting or non-splitting of the current coding unit based on the determined merging or non-merging of the current coding unit, and determining the split structure of the current coding tree unit by splitting the current coding unit or omitting the splitting of the current coding unit based on a determined splitting or non-splitting, and generating a prediction block of the current coding unit by using the split structure of the current coding tree unit.

The present disclosure in another embodiment provides a video encoding method including predicting a split structure of a current coding tree unit, determining a merging or non-merging of a current coding unit within the current coding tree unit by using the split structure of the current coding tree unit, and merging the current coding unit or omitting the merging of the current coding unit based on a determined merging or non-merging of the current coding unit, determining a splitting or non-splitting of the current coding unit based on the determined merging or non-merging of the current coding unit, and determining the split structure of the current coding tree unit by splitting the current coding unit or omitting the splitting of the current coding unit based on a determined splitting or non-splitting, and generating a prediction block of the current coding unit by using the split structure of the current coding tree unit.

Further, the present disclosure may provide a method of transmitting a bitstream generated by the video encoding method or apparatus according to the present disclosure.

Further, the present disclosure may provide a recording medium storing a bitstream generated by the video encoding method or apparatus according to the present disclosure.

Further, the present disclosure may provide a recording medium storing a bitstream that is received, decoded, and utilized to reconstruct a video by the video decoding apparatus according to the present disclosure.

### Advantageous Effects

As described above, the present disclosure in some embodiments can provide method and apparatus for predicting a split structure of a coding tree unit by using reference information and a convolutional neural network.

Further, the present disclosure can provide method and apparatus for determining the split structure of a final coding tree unit by modifying the predicted split structure of the coding tree unit.

Further, the present disclosure can provide method and apparatus for increasi ng video encoding/decoding efficiency.

Effects obtainable with the present disclosure are not limited to the above-mentioned effect, and other unmentioned effects could be clearly understood by those skilled in the art from the description below.

### BRIEF DESCRIPTION OF THE DRAWINGS

FIG. 1 is a block diagram of a video encoding apparatus that may implement the techniques of the present disclosure.

FIG. 2 illustrates a method for splitting a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a flowchart of a process for reconstructing a coding unit, according to at least one embodiment of the present disclosure.

FIG. 7 is a flowchart of a process for reconstructing a coding unit by predicting and modifying a split structure of a coding tree unit, according to at least one embodiment of the present disclosure.

FIG. 8 is a flowchart of a process for determining a prediction block of a coding tree unit, according to at least one embodiment of the present disclosure.

FIG. 9 is a diagram illustrating a method of determining a prediction block of a coding tree unit, according to at least one embodiment of the present disclosure.

FIG. 10 is a diagram illustrating a process for modifying a split structure of a coding tree unit, according to at least one embodiment of the present disclosure.

FIGS. 11A to 11G are drawings illustrating methods of merging and splitting a coding unit, according to at least one embodiment of the present disclosure.

FIG. 12 is a flowchart of a video decoding process, according to at least one embodiment of the present disclosure.

FIG. 13 is a flowchart for illustrating a video encoding process, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

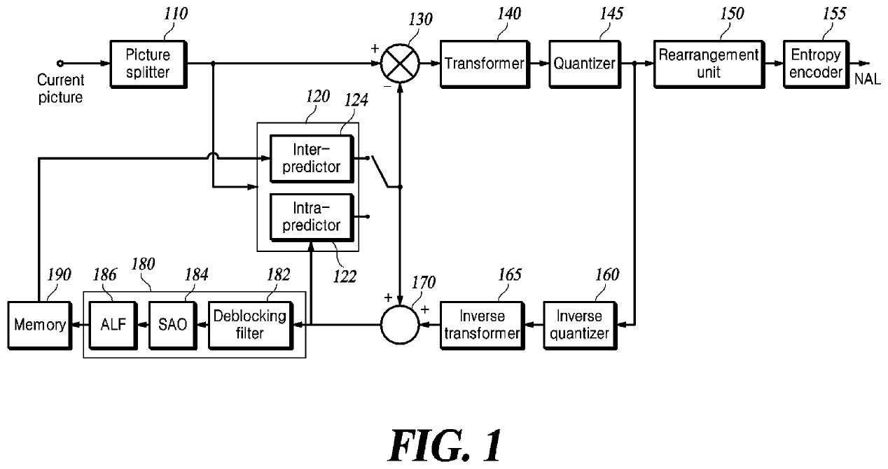

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

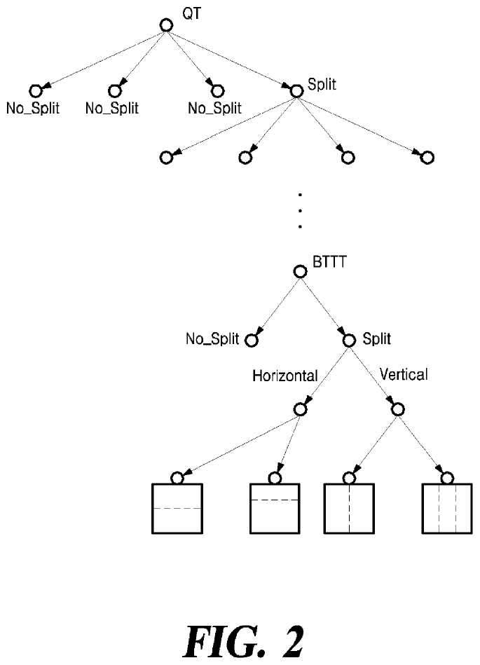

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

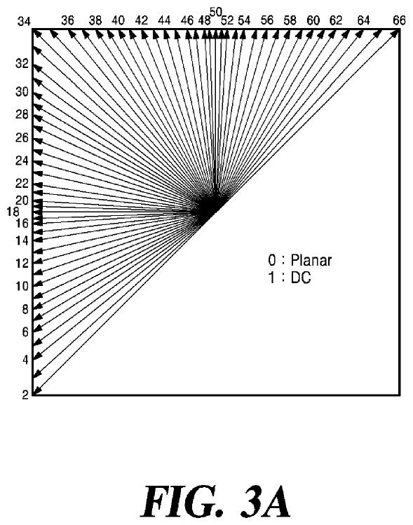

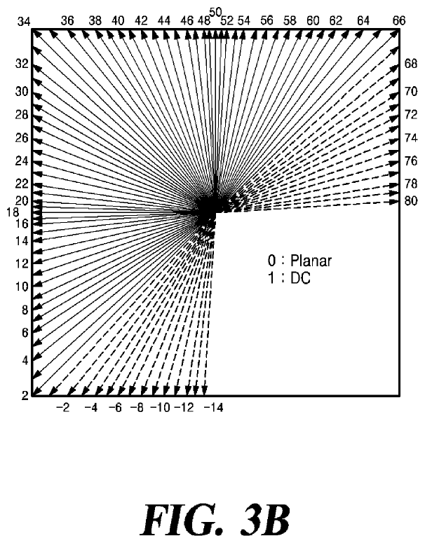

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

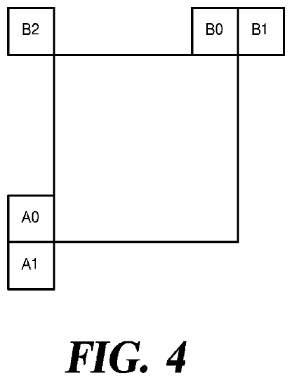

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding apparatus may store a bitstream of encoded video data in a non-transitory storage medium or transmit the bitstream to the video decoding device through a communication network.

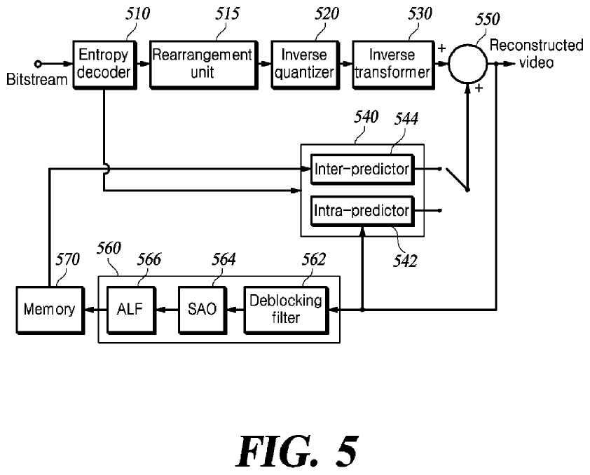

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The following embodiments may be performed by the intra predicting unit 122, the transforming unit 140, and the inverse transform unit 165 in the video encoding apparatus. They may also be performed by the inverse transform unit 530 and the intra predicting unit 542 in the video decoding apparatus. In the following, the video decoding apparatus is described as performing the respective process steps but the video encoding apparatus may also perform the same steps.

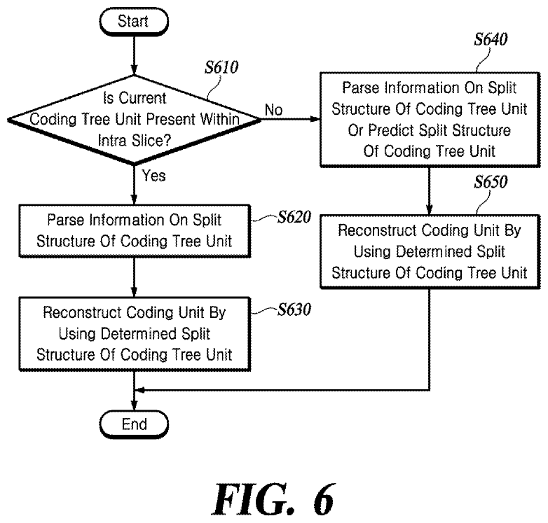

FIG. 6 is a flowchart of a process for reconstructing a coding unit, according to at least one embodiment of the present disclosure. Evenly splitting a picture may generate a coding tree unit (CTU). For example, a coding tree unit may be a 128×128 region in the top-left corner of a picture. A coding tree unit may be split into one or more coding units (CUs) and sample values may be reconstructed by coding unit. Each time a coding unit is determined, the sample value of that coding unit may be reconstructed. Alternatively, after determining all coding units in the coding tree unit, the sample value of the coding unit may be reconstructed while scanning the coding unit by using a scan order.

Referring to FIG. 6, the video decoding apparatus determines whether a current coding tree unit is present within an intra slice (S610). In the intra slice, intra prediction may be performed on all coding units within that slice. When the current coding tree unit is determined to be present within the intra slice (S610—Yes), the video decoding apparatus parses information about the split structure of the coding tree unit (S620). The split structure of the coding tree unit is the structure of the coding units that constitute the coding tree unit. The information about the split structure of the coding tree unit is used to determine the split structure of the coding tree unit. The information about the split structure of the coding tree unit may include information about the determined splitting or non-splitting of the coding tree unit, information about a split method of the coding tree unit, and information about a split direction of the coding tree unit. The video decoding apparatus reconstructs the coding unit by using the determined split structure of the coding tree unit (S630). The split structure of the coding tree unit may be determined by using information about the split structure of the parsed coding tree unit.

When the current coding tree unit is determined not to be present within the intra slice (S610—No), the video decoding apparatus parses information about the split structure of the coding tree unit or predicts the split structure of the coding tree unit (S640). If the current coding tree unit is not present within the intra slice, the current coding tree unit may be present within an inter slice. In the inter slice, intra prediction or inter prediction may be performed on coding units within that slice. If the split structure of the coding tree unit is to be predicted, the video decoding apparatus may predict the split structure of the coding tree unit by using reference information and a convolution neural network. The video decoding apparatus reconstructs the coding unit by using the determined split structure of the coding tree unit (S650). The split structure of the coding tree unit may be determined by using information about the split structure of the parsed coding tree unit. Alternatively, the split structure of the coding tree unit may be determined by using the predicted split structure of the coding tree unit.

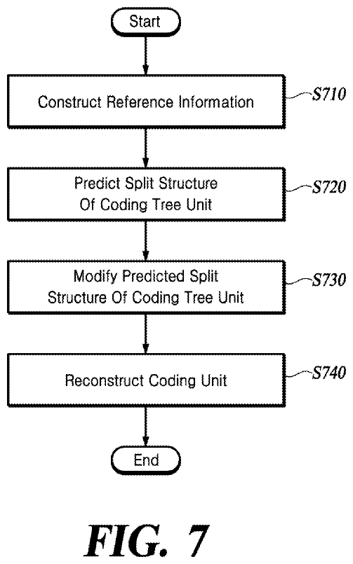

FIG. 7 is a flowchart of a process for reconstructing a coding unit by predicting and modifying a split structure of a coding tree unit, according to at least one embodiment of the present disclosure.

Referring to FIG. 7, the video decoding apparatus constructs reference information (S710). The reference information may include information about a reconstructed sample of a coding tree unit adjacent to the top of the current coding tree unit and a reconstructed sample of a coding tree unit adjacent to the left of the current coding tree unit. The reference information may include information obtained by two-dimensionally packing information about a motion vector, a quantization parameter, and a prediction mode of a coding tree unit adjacent to the top of the current coding tree unit. The reference information may include information obtained by two-dimensionally packing information about a motion vector, a quantization parameter, and a prediction mode of a coding tree unit adjacent to the left side of the current coding tree unit. The reference information may include information about a spatially identical region to the current coding tree unit in the reference picture and a neighboring region of the spatially identical region, etc. The information about a spatially identical region to the current coding tree unit in the reference picture and a neighboring region of the spatially identical region may include information about a temporal parameter or information about a splitting parameter. The reference information may include information about a prediction block of the current coding tree unit.

The video decoding apparatus predicts a split structure of the coding tree unit (S720). The split structure of the coding tree unit may be predicted by using the reference information and a convolutional neural network. A convolutional neural network is an artificial neural network used to analyze video. A convolutional neural network can extract features from a picture and process them. The video decoding apparatus modifies the predicted split structure of the coding tree unit (S730). The predicted split structure of the coding tree unit may be modified by scanning each coding unit from the predicted split structure of the coding tree unit and merging or splitting each coding unit. Coding units may be merged or split by using the merge flag and split flag. Modifying the predicted split structure of the coding tree unit determines the split structure of the final coding tree unit. The video decoding apparatus reconstructs the coding unit (S740). Each coding unit is reconstructed from the split structure of the final coding tree unit, and the sample value of each coding unit is reconstructed.

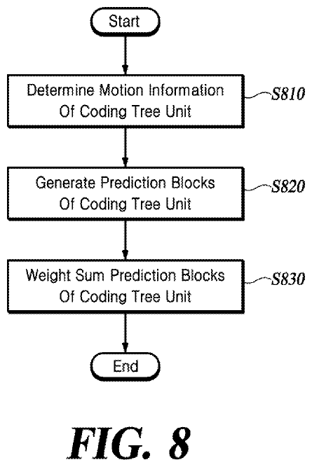

FIG. 8 is a flowchart of a process for determining a prediction block of a coding tree unit, according to at least one embodiment.

Referring to FIG. 8, the reference information may include information about a prediction block of the current coding tree unit. The video decoding apparatus determines the motion information of the current coding tree unit (S810). The motion information of the current coding tree unit may be determined by referring to the motion information of a coding tree unit adjacent to the top of the current coding tree unit and the motion information of a coding tree unit adjacent to the left of the current coding tree unit. The motion information may include information about the reference picture's index and motion vector or the like. Listed may be the motion information of the coding units in the neighboring coding tree unit at the top of the current coding tree unit and the motion information of the coding units in the neighboring coding tree unit at the left side of the current coding tree unit. Among the listed motion information items, the motion information of the current coding tree unit may be determined.

Determined as the motion information of the current coding tree unit may be the motion information of the coding unit that is closest in distance to the top-left sample of the current coding tree unit. When there are multiple coding units with the closest distance to the top-left sample of the current coding tree unit, the motion information of the coding unit with the largest size may be determined as the motion information of the current coding tree unit. The motion information of a coding unit adjacent to the top of the current coding tree unit may be determined as the motion information of the current coding tree unit. The motion information of a coding unit adjacent to the left side of the current coding tree unit may be determined as the motion information of the current coding tree unit.

The video decoding apparatus generates prediction blocks of the current coding tree unit by using the motion information of the current coding tree unit (S820). The prediction blocks may be generated with a size equal to that of the current coding tree unit. One prediction block per motion information item may be generated. Accordingly, when multiple motion information items of the current coding tree unit are determined, multiple prediction blocks of the current coding tree unit may be generated. The video decoding apparatus weight sums the prediction blocks of the current coding tree unit (S830). Weight summing the prediction blocks of the current coding tree unit may generate a final prediction block of the current coding tree unit. The weights assigned to the prediction blocks of the current coding tree unit may all be the same. The weights assigned to the prediction blocks of the current coding tree unit may be arbitrary values.

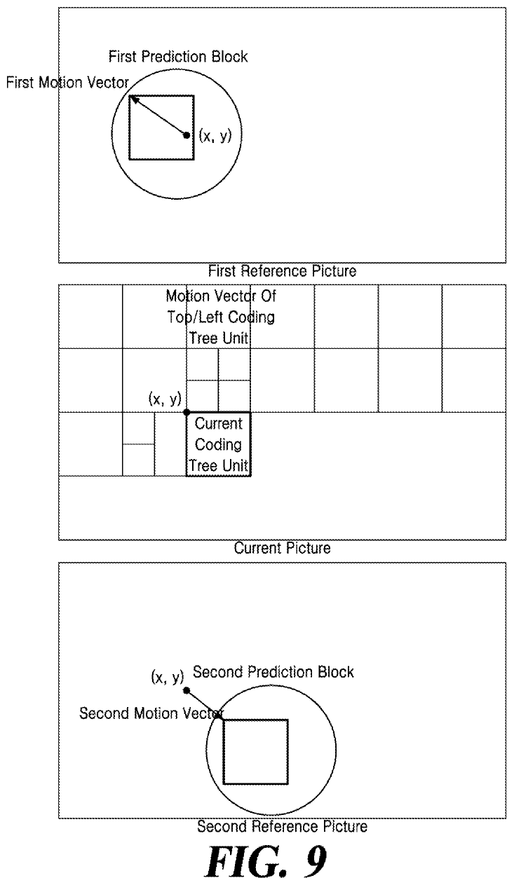

FIG. 9 is a diagram illustrating a method of determining a prediction block of a coding tree unit, according to at least one embodiment of the present disclosure.

Referring to FIG. 9, the video decoding apparatus may determine a motion vector of the current coding tree unit in the current picture by using a motion vector of a coding tree unit adjacent to the top of the current coding tree unit and a motion vector of a coding tree unit adjacent to the left of the current coding tree unit. The video decoding apparatus may use the determined motion vector of the current coding tree unit to generate a prediction block of the current coding tree unit.

The video decoding apparatus may determine an average motion vector by averaging the motion vectors in each reference picture based on the reference picture index. Excluded from here may be motion vectors in each reference picture that are significantly different from the median motion vector. The video decoding apparatus may determine the motion information of the current coding tree block by using the reference picture corresponding to the reference picture index that is least different from the index of the current picture. The video decoding apparatus may determine the average motion vector from averaging the motion vectors in the reference picture to be the motion vector of the current coding tree block.

The video decoding apparatus may determine a first motion vector from averaging the motion vectors of a first reference picture and an index of the first reference picture to be the motion information of the current coding tree block. The video decoding apparatus may use the first motion vector and the index of the first reference picture to generate a first prediction block. The video decoding apparatus may determine a second motion vector from averaging the motion vectors of a second reference picture and an index of the second reference picture to be the motion information of the current coding tree block. The video decoding apparatus may use the second motion vector and the index of the second reference picture to generate a second prediction block. The video decoding apparatus may weight-average the first prediction block and the second prediction block to generate a final prediction block. The weights assigned to the first prediction block and the second prediction block may be the same. The weights assigned to the first prediction block and the second prediction block may be arbitrary values. The weights assigned to the first prediction block and the second prediction block may be inversely proportional to the temporal distance between the current picture and the first reference picture and the temporal distance between the current picture and the second reference picture. Information about the final prediction block is included in the reference information.

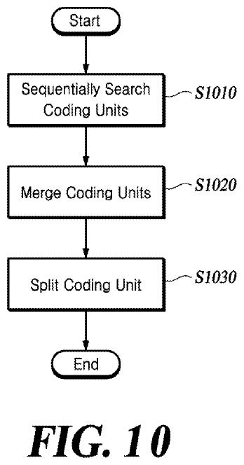

FIG. 10 is a diagram illustrating a process for modifying a split structure of a coding tree unit, according to at least one embodiment of the present disclosure.

Referring to FIG. 10, the video decoding apparatus sequentially searches the coding units by using the predicted split structure of the coding tree unit (S1010). The coding units to be merged or split may be searched in a Z-scan order. When a coding unit is merged or split to cause a modification of the split structure of the coding tree unit, the index of each coding unit is also modified. In this case, the coding unit may be searched based on the modified index. If the coding unit is no longer split or merged, the coding unit with the following index may be searched.

The video decoding apparatus merges coding units by using the merge flag (S1020). If the merge flag (e.g., merge_flag) has a first value (e.g., 0), the coding unit may not be merged. If the merge flag (e.g., merge_flag) is the second value (e.g., 1), the coding unit may be merged. When a coding unit is merged, the current coding unit may be merged with all coding units in the parent unit of the current coding unit. If any of predetermined conditions are satisfied, the merge_flag may be derived to be the first value (e.g., 0). The first of the predetermined conditions is a condition of whether a split coding unit is present among the lower coding units of the parent unit of the current coding unit. The second condition is a condition of whether a merging has not occurred in a coding unit with the same depth as the current coding unit, among the lower coding units of the parent unit of the current coding unit. The third condition is a condition of whether the current coding unit has been generated by splitting.

The video decoding apparatus splits the coding unit by using a split flag (S1030). When the split flag (e.g., split_flag) has the first value (e.g., 0), the coding unit may not be split. If the split flag (e.g., split_flag) is the second value (e.g., 1), the coding unit may be split. When the coding unit is split, the current coding unit may be split into two or more coding units. If split_flag is the second value (e.g., 1), information about the split method and information about the split direction may be parsed. The information about the split method may include information about quadtree splitting, binary tree splitting, and three-way tree splitting. The information about the split direction may include information about the vertical direction and the horizontal direction, etc. If any of predetermined conditions is satisfied, the split_flag may be derived to be the first value (e.g., 0). The first of the predetermined conditions is a condition of whether the merge_flag of the current coding unit is the second value (e.g., 1). The second condition is a condition of whether the width, height, and area of the current coding unit are equal to the lower threshold. The video decoding apparatus may first determine the merging or non-merging of the current coding unit, and then determine the partiting or non-splitting of the current coding unit. Alternatively, the video decoding apparatus may prioritize determining the splitting or non-splitting of the current coding unit, and then determine the merging or non-merging of the current coding unit.

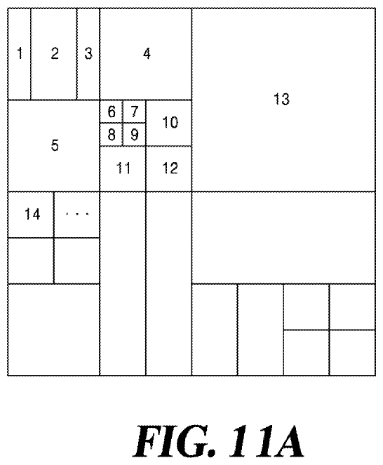

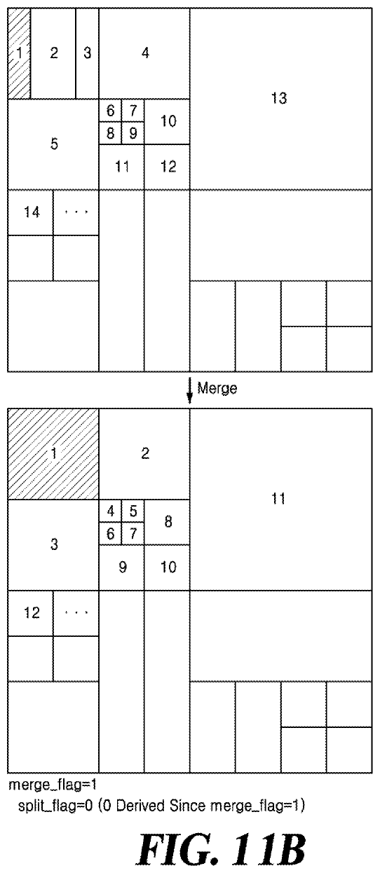

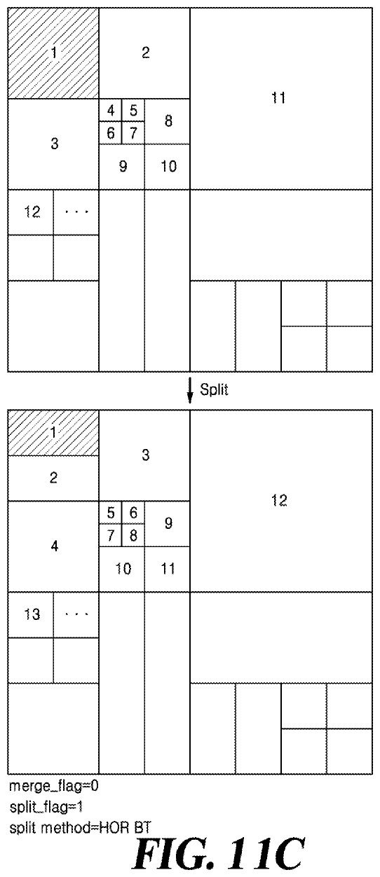

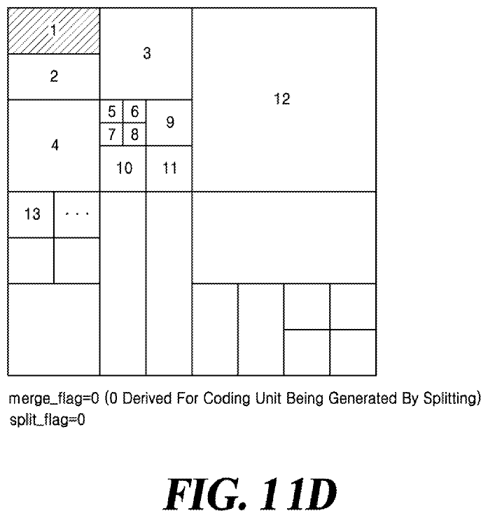

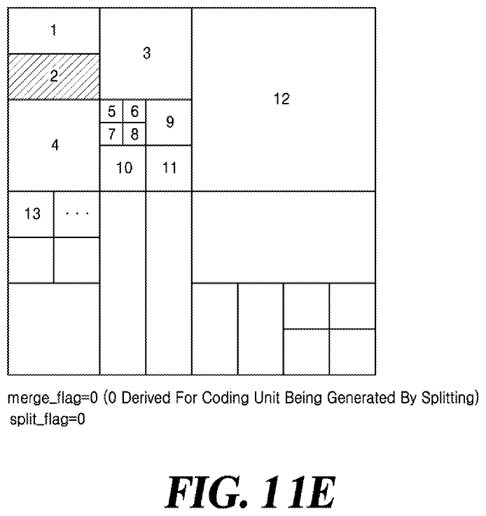

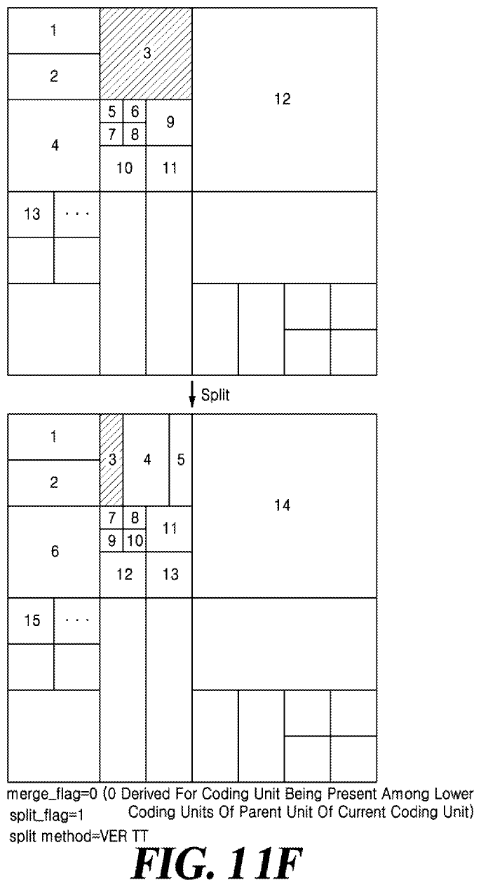

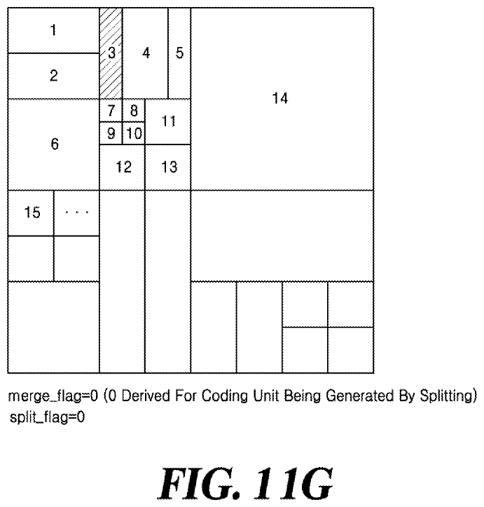

FIGS. 11A to 11G are drawings illustrating methods of merging and splitting a coding unit, according to at least one embodiment of the present disclosure.

Referring to FIG. 11A, the video decoding apparatus determines a predicted split structure of the coding tree unit. In the predicted split structure of the coding tree unit, three coding units in the parent unit at the top left may be assigned index 1, index 2, and index 3 in order from left to right. The coding unit adjacent to the right of the parent unit at the top left may be assigned index 4. The coding unit adjacent to the bottom in the parent unit at the top left may be assigned index 5. Similarly, the remaining coding units may be assigned indices.

Referring to FIG. 11B, the video decoding apparatus may obtain a merge_flag for the coding unit assigned index 1. Since the merge_flag is the second value (e.g., 1), the video decoding apparatus may merge within the parent unit the coding unit assigned index 1, the coding unit assigned index 2, and the coding unit assigned index 3. The merged coding unit may be assigned index 1. Since merge_flag has the second value (e.g., 1), split_flag may be derived to be the first value (e.g., 0). Since split_flag is derived to be the first value (e.g., 0), the video decoding apparatus may not split the coding unit initially assigned index 1.

Referring to FIG. 11C, the video decoding apparatus may obtain merge_flag for the merged coding unit assigned index 1 in FIG. 11B. Since merge_flag is the first value (e.g., 0), merging may not be performed. The video decoding apparatus may obtain a split_flag for the merged coding unit assigned index 1. Since the split_flag is the second value (e.g., 1) and the information about the split method indicates a binary tree splitting in the horizontal direction, the merged coding unit assigned index 1 may be split into two coding units in the horizontal direction. Of these two coding units, the top coding unit may be assigned index 1 and the bottom coding unit may be assigned index 2. The coding unit adjacent to the right of these two coding units may be assigned index 3.

Referring to FIG. 11D, the top coding unit assigned index 1 in FIG. 11C is a coding unit generated by splitting, so merge_flag may be derived to be the first value (e.g., 0). Since the merge_flag is the first value (e.g., 0), merging may not be performed. The video decoding apparatus may obtain a split_flag for the top coding unit assigned index 1. Since the split_flag is the first value (e.g., 0), splitting may not be performed.

Referring to FIG. 11E, since the bottom coding unit assigned index 2 in FIG. 11C is a coding unit generated by splitting, merge_flag may be derived to be the first value (e.g., 0). Since the merge_flag is the first value (e.g., 0), merging may not be performed. The video decoding apparatus may obtain a split_flag for the bottom coding unit assigned index 2. Since the split_flag is the first value (e.g., 0), splitting may not be performed.

Referring to FIG. 11F, since there is a split coding unit among the lower coding units of the parent unit of the coding unit assigned index 3 in FIG. 11C, merge_flag may be derived to be the first value (e.g., 0). Among the lower coding units of the parent unit of the coding unit assigned index 3, the split coding units are the top coding unit assigned index 1 and the bottom coding unit assigned index 2. Since the merge_flag is the first value (e.g., 0), merging may not be performed. The video decoding apparatus may obtain a split_flag for the coding unit assigned index 3. Since the split_flag is the second value (e.g., 1) and the information about the split method indicates a three-way tree splitting in the vertical direction, the coding unit assigned index 3 may be split into three coding units in the vertical direction. Among these three coding units, the left coding unit may be assigned index 3, the center coding unit may be assigned index 4, and the right coding unit may be assigned index 5.

Referring to FIG. 11G, the left coding unit assigned index 3 in FIG. 11F is a coding unit generated by splitting, so merge_flag may be derived to be the first value (e.g., 0). Since merge_flag is the first value (e.g., 0), merging may not be performed. The video decoding apparatus may obtain a split_flag for the left coding unit assigned index 3. Since the split_flag is the first value (e.g., 0), splitting may not be performed.

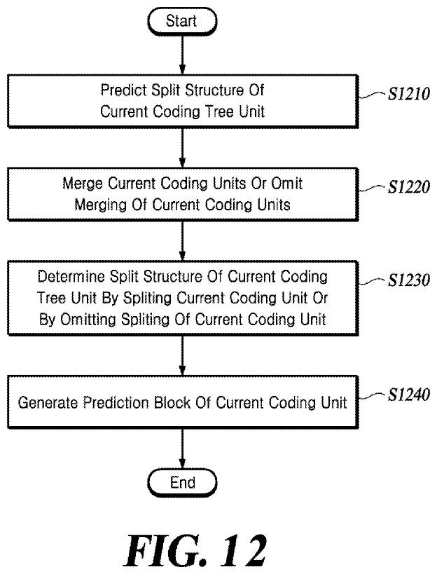

FIG. 12 is a flowchart of a video decoding process, according to at least one embodiment of the present disclosure.

Referring to FIG. 12, the video decoding apparatus predicts a split structure of the current coding tree unit (S1210). The process of predicting the split structure of the current coding tree unit may include obtaining reference information and using the reference information and a neural network to predict the split structure of the current coding tree unit.

The reference information may include at least one of information on a reconstructed sample of a coding tree unit adjacent to the top of the current coding tree unit and a reconstructed sample of a coding tree unit adjacent to the left of the current coding tree unit, information obtained by two-dimensionally packing information about a motion vector, a quantization parameter, and a prediction mode of the coding tree unit adjacent to the top and the left of the current coding tree unit, information on a spatially identical region to the current coding tree unit in the reference picture and a neighboring region of the spatially identical region, and information on a prediction block of the current coding tree unit.

The video decoding apparatus uses the split structure of the current coding tree unit to determine a merging or non-merging of the current coding units within the current coding tree unit and merges the current coding units or omits the merging of the same based on the determined merging or non-merging (S1220). The process of merging the current coding unit or omitting the merging thereof may include omitting the merging of the current coding unit based on satisfying at least one of predetermined conditions. The predetermined conditions may include a condition of whether or not a split coding unit is present among the lower coding units of the parent unit of the current coding unit, a condition of whether a merging has not occurred in a coding unit having the same depth as the current coding unit, among the lower coding units of the parent unit of the current coding unit, and a condition of whether or not the current coding unit has been generated by splitting.

The video decoding apparatus determines a splitting or non-splitting of the current coding unit based on the determined merging or non-merging of the current coding unit and determines a split structure of the current coding tree unit by splitting the current coding unit based on the determined splitting or non-splitting, or by omitting the splitting of the current coding unit (S1230). The process of determining the split structure of the current coding tree unit may include determining the split structure of the current coding tree unit by omitting the splitting of the current coding unit based on satisfying at least one of predetermined conditions. The predetermined conditions may include a condition of whether or not the current coding unit is merged, and a condition of whether the width, height, and area of the current coding unit are equal to predetermined values. The video decoding apparatus uses the split structure of the current coding tree unit to generate a prediction block of the current coding unit (S1240).

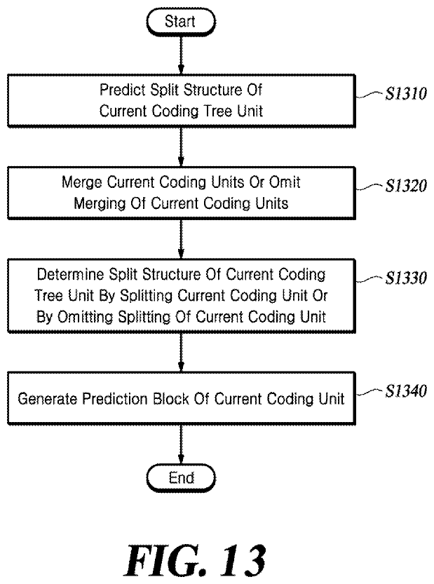

FIG. 13 is a flowchart for illustrating a video encoding process, according to at least one embodiment of the present disclosure.

The video encoding apparatus predicts a split structure of the current coding tree unit (S1310). The process of predicting the split structure of the current coding tree unit may include obtaining reference information and using the reference information and a neural network to predict the split structure of the current coding tree unit.

The reference information may include at least one of information on a reconstructed sample of a coding tree unit adjacent to the top of the current coding tree unit and a reconstructed sample of a coding tree unit adjacent to the left of the current coding tree unit, information obtained by two-dimensionally packing information about a motion vector, a quantization parameter, and a prediction mode of the coding tree unit adjacent to the top and the left of the current coding tree unit, information on a spatially identical region to the current coding tree unit in the reference picture and a neighboring region of the spatially identical region, and information on a prediction block of the current coding tree unit.

The video encoding apparatus may utilize the split structure of the current coding tree unit to determine a merging or non-merging of the current coding units within the current coding tree unit, and it may merge the current coding units or omit merging of the same based on the determined merging or non-merging (S1320). The process of merging the current coding units or omitting the merging thereof may include omitting the merging of the current coding units based on satisfying at least one of predetermined conditions. The predetermined conditions may include a condition of whether or not a split coding unit is present among the lower coding units of the parent unit of the current coding unit, a condition of whether a merging has not occurred in a coding unit having the same depth as the current coding unit, among the lower coding units of the parent unit of the current coding unit, and a condition of whether or not the current coding unit has been generated by splitting.

The video encoding apparatus determines a splitting or non-splitting of the current coding unit based on the determined merging or non-merging of the current coding unit, and it determines a split structure of the current coding tree unit by splitting the current coding unit based on the determined splitting or non-splitting, or by omitting the splitting of the current coding unit (S1330). The process of determining the split structure of the current coding tree unit may include determining the split structure of the current coding tree unit by omitting the splitting of the current coding unit based on satisfying at least one of predetermined conditions. The predetermined conditions may include a condition of whether or not the current coding units are merged, and a condition of whether the width, height, and area of the current coding unit are equal to predetermined values. The video encoding apparatus uses the split structure of the current coding tree unit to generate a prediction block of the current coding unit (S1340).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A video decoding method, comprising:
predicting a split structure of a current coding tree unit;
determining a merging or non-merging of a current coding unit within the current coding tree unit by using the split structure of the current coding tree unit, and merging the current coding unit or omitting the merging of the current coding unit based on a determined merging or non-merging of the current coding unit;
determining a splitting or non-splitting of the current coding unit based on the determined merging or non-merging of the current coding unit, and determining the split structure of the current coding tree unit by splitting the current coding unit or omitting the splitting of the current coding unit based on a determined splitting or non-splitting; and
generating a prediction block of the current coding unit by using the split structure of the current coding tree unit.

2. The video decoding method of claim 1, wherein the predicting the split structure of the current coding tree unit comprises:
obtaining reference information; and
predicting the split structure of the current coding tree unit by using the reference information and a neural network.

3. The video decoding method of claim 2, wherein the reference information comprises at least one of:
information about a reconstructed sample of a coding tree unit adjacent to a top of the current coding tree unit and a reconstructed sample of a coding tree unit adjacent to a left side of the current coding tree unit,
information obtained by two-dimensionally packing information about a motion vector, a quantization parameter, and a prediction mode of a coding tree unit adjacent to the top and the left side of the current coding tree unit,
information about a spatially identical region to the current coding tree unit in a reference picture and a neighboring region of the spatially identical region, and
information about a prediction block of the current coding tree unit.

4. The video decoding method of claim 1, wherein the merging of the current coding unit or omitting the merging of the current coding unit comprises:
omitting the merging of the current coding unit based on satisfying at least one of predetermined conditions.

5. The video decoding method of claim 4, wherein the predetermined conditions comprise:
a condition of whether there is a split coding unit among lower coding units of a parent unit of the current coding unit,
a condition of whether a merging has not occurred in a coding unit that is identical in depth to the current coding unit among the lower coding units of the parent unit of the current coding unit, and
a condition of whether the current coding unit has been generated by splitting.

6. The video decoding method of claim 1, wherein the determining the split structure of the current coding tree unit comprises:
determining the split structure of the current coding tree unit by omitting the splitting of the current coding unit based on satisfying at least one of predetermined conditions.

7. The video decoding method of claim 6, wherein the predetermined conditions comprise:
a condition of whether the current coding unit is merged and
a condition of whether a width, a height, and an area of the current coding unit are equal to predetermined values.

8. A video encoding method, comprising:
predicting a split structure of a current coding tree unit;
determining a merging or non-merging of a current coding unit within the current coding tree unit by using the split structure of the current coding tree unit, and merging the current coding unit or omitting the merging of the current coding unit based on a determined merging or non-merging of the current coding unit;
determining a splitting or non-splitting of the current coding unit based on the determined merging or non-merging of the current coding unit, and determining the split structure of the current coding tree unit by splitting the current coding unit or omitting the splitting of the current coding unit based on a determined splitting or non-splitting; and
generating a prediction block of the current coding unit by using the split structure of the current coding tree unit.

9. The video encoding method of claim 8, wherein the predicting the split structure of the current coding tree unit comprises:
determining reference information; and
predicting the split structure of the current coding tree unit by using the reference information and a neural network.

10. The video encoding method of claim 9, wherein the reference information comprises at least one of:
information about a reconstructed sample of a coding tree unit adjacent to a top of the current coding tree unit and a reconstructed sample of a coding tree unit adjacent to a left side of the current coding tree unit,
information obtained by two-dimensionally packing information about a motion vector, a quantization parameter, and a prediction mode of a coding tree unit adjacent to the top and the left side of the current coding tree unit,
information about a spatially identical region to the current coding tree unit in a reference picture and a neighboring region of the spatially identical region, and
information about a prediction block of the current coding tree unit.

11. The video encoding method of claim 8, wherein the merging of the current coding unit or omitting the merging of the current coding unit comprises:
omitting the merging of the current coding unit based on satisfying at least one of predetermined conditions.

12. The video encoding method of claim 11, wherein the predetermined conditions comprise:
a condition of whether there is a split coding unit among lower coding units of a parent unit of the current coding unit,
a condition of whether a merging has not occurred in a coding unit that is identical in depth to the current coding unit among the lower coding units of the parent unit of the current coding unit, and
a condition of whether the current coding unit has been generated by splitting.

13. The video encoding method of claim 8, wherein the determining the split structure of the current coding tree unit comprises:
determining the split structure of the current coding tree unit by omitting the splitting of the current coding unit based on satisfying at least one of predetermined conditions.

14. The video encoding method of claim 13, wherein the predetermined conditions comprise:
a condition of whether the current coding unit is merged and
a condition of whether a width, a height, and an area of the current coding unit are equal to predetermined values.

15. A computer-readable recording medium storing a bitstream generated by a video encoding method that comprises:
predicting a split structure of a current coding tree unit;
determining a merging or non-merging of a current coding unit within the current coding tree unit by using the split structure of the current coding tree unit, and merging the current coding unit or omitting the merging of the current coding unit based on a determined merging or non-merging of the current coding unit;
determining a splitting or non-splitting of the current coding unit based on the determined merging or non-merging of the current coding unit, and determining the split structure of the current coding tree unit by splitting the current coding unit or omitting the splitting based on a determined splitting or non-splitting; and
generating a prediction block of the current coding unit by using the split structure of the current coding tree unit.
